(19) United States
(12) Patent Application Publication
(10) Pub. No.: US 2026/0261413 A1
(43) Pub. Date: Sep. 3, 2026

(54) HARDWARE ROOT OF TRUST (HROT) SYSTEM FOR SECURE CRYPTOGRAPHIC KEY GENERATION, MANAGEMENT, AND RECOVERY IN DISTRIBUTED STORAGE ENVIRONMENTS

(71) Applicant: TGrid Technologies Pty Ltd, Sydney (AU)

(72) Inventors: Santosh Devaraj, Bellevue Hill (AU); John A Fortkort, Austin, TX (US); Arvind Manchenahalli, Nandini Layout (IN); Sharansh Guha, Bengaluru (IN); Akshay Manohar Kurhekar, Amravati Rural (IN); Aryan Saxena, Jaipur (IN); Abhiram Satpute, Indore (IN)

(21) Appl. No.: 19/448,034

(22) Filed: Jan. 13, 2026

Related U.S. Application Data
(60) Provisional application No. 63/744,625, filed on Jan. 13, 2025.

(51) Int. Cl. H04L 9/08; H04L 9/32

(52) U.S. Cl. CPC H04L 9/0869; H04L 9/085; H04L 9/0897; H04L 9/3242

(57) ABSTRACT

A method (101) securely generates, stores, and manages cryptographic keys in an HRoT-enabled system. The method includes generating a cryptographic key (103) using a TRNG (121), combining the key with a user-defined PIN and a biometric hash (105), and applying an HMAC operation (141) to produce a cryptographically secure, irreversible key (143). Shamir's Secret Sharing (151) divides the HMAC-generated key into multiple shares (109) such that a threshold number of shares (153) is required for reconstruction. The shares (111) are distributed across secure storage locations (161), with at least one share stored within the HRoT environment (163). A recovery mechanism (113) retrieves and combines the required shares within the HRoT (171) to reconstruct the original cryptographic key following successful user authentication (173).

### CROSS-REFERENCE TO RELATED APPLICATIONS

The present application claims the benefit of priority from U.S. Provisional Application No. 63/744,625, filed on Jan. 13, 2025, which has the same title and the same inventors, and which is incorporated herein by reference in its entirety.

### FIELD OF THE DISCLOSURE

The present disclosure relates generally to cybersecurity and cryptography, and more specifically to hardware-based security systems and secure key management.

### BACKGROUND OF THE DISCLOSURE

Cryptographic keys are essential for protecting sensitive data and ensuring secure authentication across a wide range of digital applications, including mobile wallets, online banking, and secure communication. In response to the growing threats of unauthorized access and data breaches, various key management systems have been developed to ensure that these cryptographic keys remain secure throughout their lifecycle.

In traditional systems, cryptographic keys are often generated and stored in software-based key storage systems or device-specific secure storage areas, such as keychains or secure application storage. While these approaches offer some level of protection, they are vulnerable to attacks, particularly if the device's main operating system becomes compromised.

To mitigate these risks, hardware-based solutions have become popular in the realm of secure key management. Such systems use dedicated hardware components to store and manage cryptographic keys, ensuring that sensitive key data remains isolated from the main system. These hardware solutions commonly include Trusted Execution Environments (TEEs) and Hardware Root of Trust (HRoT) frameworks, which have gained traction for their ability to protect keys at the hardware level.

### SUMMARY OF THE DISCLOSURE

In one aspect, a method is provided for securely generating, storing, and managing cryptographic keys in a Hardware Root of Trust (HRoT)-enabled system. The method comprises generating a cryptographic key using a True Random Number Generator (TRNG) and combining it with a user-defined Personal Identification Number (PIN) and a biometric hash of the user's biometric data; encrypting the combined key using a Hash-Based Message Authentication Code (HMAC) operation to generate a cryptographically secure and irreversible key; utilizing Shamir's Secret Sharing to divide the HMAC-generated key into multiple key shares, wherein a threshold number of shares is required to reconstruct the original key; distributing the key shares across secure storage locations, with at least one share stored within the HRoT environment; and implementing a recovery mechanism whereby the stored key shares can be retrieved, decrypted, and combined within the HRoT to reconstruct the original cryptographic key upon successful user authentication.

In another aspect, a hardware root of trust (HRoT) system for securing cryptographic key management is provided. The system comprises a secure key generation module configured to generate a cryptographic key using a combination of TRNG, user PIN, and biometric data; a key storage module that divides the cryptographic key into multiple shares via Shamir's Secret Sharing, storing each share in distinct secure storage locations; and an HRoT recovery module configured to reassemble the cryptographic key using a threshold number of shares upon successful user authentication.

In a further aspect, a method for implementing a secure cryptographic system in a distributed storage environment. The method comprises dynamically generating cryptographic keys using hardware-based entropy sources; segmenting the generated cryptographic keys into threshold-defined shares using a polynomial-based secret sharing mechanism; associating each key share with metadata tags denoting storage location and access permissions; transmitting the key shares via a secure channel to designated storage systems, including a primary share stored within a Hardware Root of Trust (HRoT); and executing a tamper-evident reconstruction protocol to reassemble the key exclusively within the HRoT upon successful multi-factor authentication.

In another aspect, a method for secure cross-device cryptographic key recovery is provided. The method comprises storing device-specific cryptographic key shares in multiple distributed locations, including device-level secure modules, cloud-based encrypted vaults, and blockchain networks; authenticating a user via hardware-secured biometric and passcode verification; dynamically reconstructing the original cryptographic key within an HRoT environment using a threshold number of retrieved shares; and providing the reconstructed key exclusively for cryptographic operations within a trusted execution environment.

In still another aspect, a method for ensuring the resilience of cryptographic keys against quantum computational threats is provided. The method comprises generating quantum-resistant cryptographic keys using a True Random Number Generator (TRNG) integrated with post-quantum cryptographic algorithms; distributing the keys via a hybrid storage model employing both HRoT-based modules and post-quantum encrypted distributed storage systems; implementing a recovery protocol utilizing quantum-resistant hashing and threshold-based secret sharing for key reconstruction; and maintaining audit logs with post-quantum digital signatures for all key-related operations within the system.

In yet another aspect, a cryptographic key management system utilizing a Hardware Root of Trust (HRoT) is provided. The system comprises a secure key generation module capable of integrating user-specific biometrics with hardware-generated entropy; a distributed storage management subsystem utilizing both on-premises HRoT and external secure cloud storage; a cryptographic key reconstruction module configured to validate user authenticity through multi-factor mechanisms and securely reconstruct keys via threshold-based polynomial interpolation; and an incident response system that dynamically revokes, rekeys, and redistributes shares in response to unauthorized access attempts.

In another aspect, a hardware-embedded cryptographic security framework for multi-device ecosystems is provided. The framework comprises an HRoT embedded within each device for local key management and generation; a decentralized ledger for securely logging and distributing cryptographic key shares; a synchronization module that facilitates cross-device key recovery via secure share retrieval and HRoT-based reconstruction; and an adaptive authentication mechanism that enhances security by utilizing contextual factors, such as geolocation and device activity history, during key recovery.

### BRIEF DESCRIPTION OF THE DRAWINGS

FIG. 1 is an illustration of a method for securely generating, storing, and managing cryptographic keys in a Hardware Root of Trust (HRoT)-enabled system in accordance with the teachings herein.

### DETAILED DESCRIPTION

Despite their many advantages, current hardware-based systems still face challenges in enabling secure, user-friendly key recovery and cross-device portability. These shortcomings arise from various features of these systems.

Some issues relate to the use of Trusted Execution Environments (TEE). A TEE is a secure area within a device's processor that isolates the execution of sensitive operations from the main operating system. This isolation allows critical cryptographic operations to be performed securely even if the main system is compromised. For example, TEE solutions such as the Android KeyStore or Apple's Secure Enclave execute cryptographic processes in an isolated environment. While TEEs improve security by preventing unauthorized access to key operations, they do not inherently support cross-device recovery and are often limited by device-specific constraints.

Other issues relate to Hardware Root of Trust (HRoT). An HRoT is a secure hardware component embedded within a device that forms the foundational trust anchor for cryptographic operations. HRoTs are designed to securely store and manage cryptographic keys, validate firmware integrity, and protect the device's boot process against tampering. For instance, HRoT components can store a device's root cryptographic keys, which are then used to establish trusted states for the entire device. However, conventional HRoT implementations generally lack mechanisms for distributed key recovery or backup across devices, limiting usability in scenarios where users need seamless access to their cryptographic assets.

Further issues relate to conventional key storage and management techniques. Various software-based and hybrid solutions for key storage are currently known to the art, such as device keychains and secure databases. In these systems, cryptographic keys are either encrypted and stored within the application or securely stored in the device's memory. While such methods provide basic security, they remain vulnerable to attacks that target the software layer or device memory, especially if attackers gain access to the device's main operating system. Furthermore, software-based encryption typically lacks the hardware-level isolation provided by TEEs and HRoTs, making it less effective against advanced threats.

Still other issues relate to software-based key recovery and backup mechanisms. In particular, existing key recovery solutions often rely on cloud-based or software-based backup mechanisms, where encrypted copies of cryptographic keys are stored remotely and retrieved when needed. This method, however, poses security risks as it introduces potential points of failure in the backup system, particularly if the remote server is compromised. Additionally, key recovery through cloud-based backups can be cumbersome and may require extensive user authentication steps, compromising the overall user experience. Such methods are also susceptible to issues like data loss or synchronization errors, which could prevent successful recovery of cryptographic keys.

While key management systems have been proposed in the prior art that integrate TEEs, HRoT, and other cryptographic techniques, these solutions often face several limitations. For example, current HRoT and TEE solutions do not inherently support a mechanism for secure cross-device recovery of cryptographic keys. This limitation makes it challenging for users to securely transfer keys across devices in cases of device loss, upgrade, or reinstallation.

Traditional HRoT systems also typically store cryptographic keys within a single device. In scenarios where multiple storage locations are desired for redundancy and security (e.g., Shamir's Secret Sharing), existing HRoT frameworks lack built-in mechanisms to distribute and manage key shares across multiple locations.

Many secure key management systems prioritize security over usability, often leading to cumbersome recovery processes that require extensive user authentication steps. While these methods enhance security, they can compromise user experience, especially for applications where ease of access is crucial, such as mobile wallets.

Finally, in some cases, cryptographic keys stored within a single HRoT or TEE may represent a single point of failure if the device is lost or corrupted. This vulnerability becomes particularly problematic in systems without distributed key storage or multi-factor recovery mechanisms.

Preferred embodiments of the systems and methodologies disclosed herein address some or all of the foregoing issues in the prior art through the provision of a comprehensive solution which addresses the challenges of secure key management by integrating hardware-level security with advanced cryptographic techniques and multi-factor recovery methods. In particular, preferred embodiments of the systems and methodologies disclosed herein introduce a secure, distributed key management system that combines HRoT with Shamir's Secret Sharing, True Random Number Generators (TRNGs), and multi-factor authentication mechanisms. This system aims to provide a more resilient key management framework that allows for cross-device key recovery, enhanced resilience with distributed storage, and seamless user authentication. Thus, by leveraging HRoT in combination with TEE and secure distributed storage mechanisms, preferred embodiments of the systems and methodologies disclosed herein enable cryptographic keys to be securely recovered and reconstructed across multiple devices. By using Shamir's Secret Sharing, preferred embodiments of the systems and methodologies disclosed herein distribute cryptographic key shares across multiple secure locations, reducing the risk of single-point failures and enhancing the robustness of the system against attacks. By integrating biometric data and PINs with TRNG-based key generation, preferred embodiments of the systems and methodologies disclosed herein provide a personalized and secure approach to key management that enhances both security and usability.

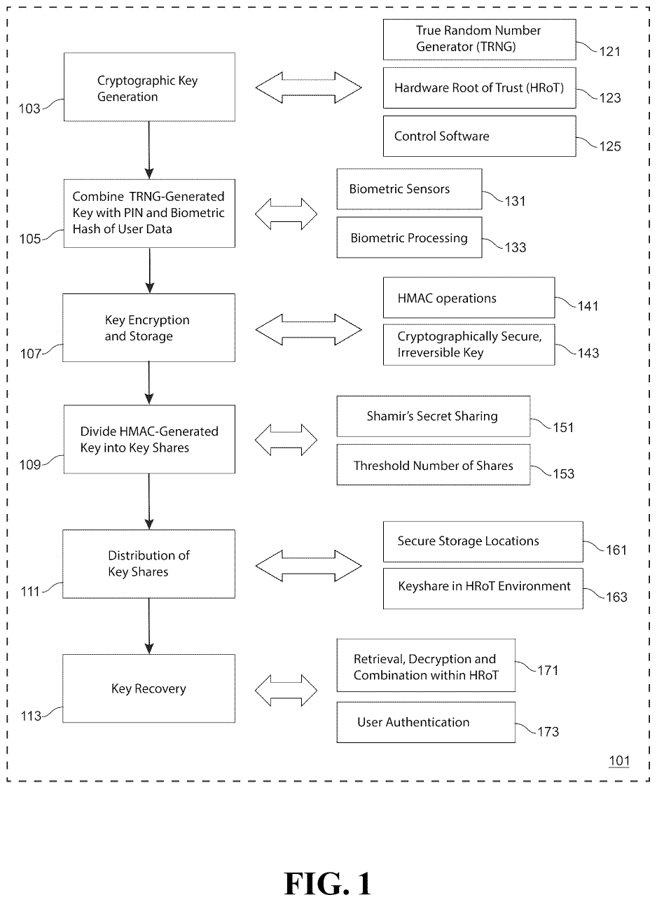

The systems and methodologies disclosed herein may be further understood with reference to FIG. 1, which depicts a particular, non-limiting embodiment of a method for securely generating, storing, and managing cryptographic keys in a Hardware Root of Trust (HRoT)-enabled system in accordance with the teachings herein. The method 101 depicted therein commences with generating a cryptographic key 103 using a True Random Number Generator (TRNG) 121. The TRNG 121 is a hardware component specifically designed to generate random numbers derived from physical processes, as opposed to deterministic computational algorithms. These physical processes may include, for example, electronic noise, thermal noise, or other quantum phenomena, which are inherently unpredictable and provide high entropy.

The TRNG 121 is integrated into the Hardware Root of Trust (HRoT) 123, a secure hardware module that serves as the foundational trust anchor for cryptographic operations. The HRoT 123 is responsible for protecting the output of the TRNG 121 and ensuring that the random numbers generated are not accessible to potentially malicious software or hardware outside the secure environment.

The TRNG 121 within the HRoT 123 is designed with specific features to resist tampering and external interference, which may compromise the randomness of the numbers generated. These features may include suitable shielding against electromagnetic interference, mechanisms to detect and respond to tampering attempts, and strict access controls.

Various firmware or secure software may be running within the HRoT 123. These include, without limitation, control software 125, security protocols, post-processing algorithms, cryptographic modules or functions, and monitoring and diagnostic software.

The control software 125 is firmware or a secure software stack specifically developed to operate within the secure boundary of the HROT 123. Its primary role is to manage the operation of the TRNG 121, including the initiation of random number generation processes, handling the retrieval of random numbers, and the post-processing of these numbers to ensure they meet required cryptographic standards.

The control software 125 preferably includes robust security protocols designed to maintain the integrity and confidentiality of the random numbers generated. This includes ensuring that the outputs of the TRNG 121 are not predictable or reproducible if the device is rebooted or subjected to power analysis attacks.

Despite the high entropy of hardware-generated random numbers, additional software-based post-processing may be applied to eliminate any bias or residual predictability from the raw output. These algorithms may include, for example, von Neumann correction, XORing consecutive bits, or other statistical methods to ensure uniform distribution and independence of the numbers.

Once the key generation process is complete, the output of the TRNG 121 is used as a cryptographic key or as a basis for cryptographic operations. The control software 125 ensures that these keys are directly passed to other cryptographic modules within the HRoT 123 for immediate use in encryption, digital signing, or other security functions without exposing them to less secure parts of the system.

The control software 121 also preferably includes capabilities to monitor the performance and health of the TRNG 121, including diagnosing potential hardware or software failures that could affect the quality of randomness. Alerts can be generated if the randomness falls below acceptable thresholds, prompting maintenance or a review of the operational integrity of the TRNG.

Following key generation, the TRNG-generated key is combined with a user-defined Personal Identification Number (PIN) and a biometric hash of the user's biometric data 105. This step may be accomplished using various hardware and software resources, including biometric sensors 131 and biometric processing software 133.

Suitable biometric sensors 131 which may be used for this step include fingerprint scanners, facial recognition cameras, iris scanners, and voice recognition microphones. Each type of sensor may be optimized to capture specific types of biometric data reliably and accurately. These sensors may be integrated into devices (such as smartphones, tablets, or dedicated security devices) where they need to be physically secure against tampering and interception. This may include embedding sensors such that any attempt to remove or manipulate them triggers security protocols that lock the device or erase sensitive data.

The quality of biometric sensors 131 affects the reliability and security of the biometric data they collect. For this reason, the use of high-resolution sensors with advanced features such as liveness detection (to prevent spoofing) and enhanced sensitivity (for accurate data capture under various conditions) is preferred.

Various biometric processing software 133 may be required for the implementation of this step.

When a biometric sensor 131 captures data, this raw input needs preprocessing to remove noise and enhance features important for identification. For example, fingerprint images may be enhanced to clarify ridge patterns, while facial recognition systems may adjust for varying lighting conditions and angles.

The software then extracts unique features from the preprocessed biometric data to create a user-specific profile. For fingerprints, this may involve identifying minutiae points; for facial recognition, this may involve identifying key facial landmarks. These features are then used to generate a cryptographic hash that uniquely represents the biometric data of the user without storing the actual images or scans, thereby enhancing privacy and security.

The software combines the cryptographic hash of the biometric data, the user's PIN, and the TRNG-generated key 105. This combination can be done through various cryptographic techniques such as concatenation followed by hashing or more complex schemes such as HMAC (Hash-Based Message Authentication Code). The goal is to intertwine the user's unique personal identifiers with the cryptographic key in a way that the resulting key is impossible to replicate without exact knowledge of all input components.

The software preferably adheres to strict security protocols to ensure that the biometric data and PIN are handled securely throughout this process. This may include using secure channels for data transmission, encrypting data at rest, and ensuring that memory handling practices prevent leakage of sensitive information.

The software also manages authentication attempts, including error handling for when biometric data does not match or when a PIN is entered incorrectly. It ensures that security is maintained through measures such as limiting the number of retry attempts and implementing delays or locks after successive failed attempts.

It will be appreciated from the foregoing that this step effectively ties the cryptographic key to the specific device and its authorized user, significantly enhancing security. By requiring both biometric verification and a PIN, the system leverages multi-factor authentication, which is far more secure than systems based on a single authentication factor. The integration of these elements within an HRoT environment ensures that the final cryptographic key is robustly protected against external threats and internal vulnerabilities, making it suitable for high-security applications such as financial transactions, secure communications, and access control systems.

The next step involves key encryption and storage 107. In the first part of the key encryption and storage step 107, encryption software is utilized to perform HMAC operations 141, ensuring the integrity and confidentiality of the key. In this step, the combined key is encrypted using a Hash-Based Message Authentication Code (HMAC) operation 141 to generate a cryptographically secure and irreversible key 143. This step of encrypting the combined key using a HMAC operation 141 is central to ensuring the integrity and confidentiality of the key. It preferably leverages cryptographic co-processors within the HRoT, in conjunction with encryption software to perform HMAC operations 141.

Cryptographic co-processors are specialized hardware components designed to execute cryptographic algorithms efficiently and securely. These processors are often part of the broader HRoT framework, which acts as a trust anchor for all cryptographic operations on the device. These co-processors are equipped with features that protect against various types of attacks, including physical tampering, side-channel attacks (such as, for example, timing and power analysis), and fault injection attacks. They are designed to operate securely even in hostile environments where the device may be exposed to sophisticated attacks. The cryptographic co-processors are optimized for high-performance operations to handle intense computational tasks associated with cryptographic processes such as HMAC without significant latency. This may be especially important for applications requiring real-time data protection or authentication.

The software responsible for HMAC operations manages the hashing of data using a cryptographic hash function in conjunction with a secret cryptographic key. HMAC provides both data integrity and authentication, ensuring that the encrypted key has not been altered or tampered with after it was initially encrypted.

The HMAC operations 141 preferably involve applying a hash function (such as SHA-256) to the combined input key (from the TRNG, PIN, and biometric hash) together with a secret key known only to the system. The software manages padding the data as needed and executing the hash function in two rounds (inner and outer hashes) to encapsulate the data securely. The software ensures that all cryptographic materials, including the secret keys used in the HMAC process 141, are handled securely. This includes secure key generation, storage, and destruction protocols. The software is also preferably designed to ensure that the keys are never exposed in memory or during processing outside of the cryptographic module. The software is tightly integrated with the HRoT functionalities, ensuring that all cryptographic operations are performed within the secure boundaries of the HRoT. This integration is important for maintaining the overall security posture of the system, as it prevents any external software or hardware from interfering with the cryptographic processes.

By using HMAC operations 141, the system achieves a level of security where the encrypted key is both authenticated and irreversible. The irreversibility ensures that even if an attacker obtains the HMAC output, they cannot reverse-engineer it to discover the original key components (TRNG output, PIN, or biometric hash). The authentication aspect ensures that any changes to the encrypted key during storage or transmission are detectable, providing tamper evidence.

This combination of advanced cryptographic hardware and sophisticated encryption software within an HRoT framework ensures that the cryptographic keys are not only securely generated but are also robustly protected throughout their lifecycle. This allows the system to meet the high standards for security demanded in sensitive applications such as financial services, government communications, and personal data protection.

Next, Shamir's Secret Sharing 151 is utilized to divide the HMAC-generated key into multiple key shares 109, where a threshold number of shares 153 is required to reconstruct the original key. This process is critical for ensuring that the cryptographic key remains protected even in distributed storage scenarios, providing both security and flexibility in key management strategies.

Shamir's Secret Sharing 151 is based on polynomial interpolation, specifically leveraging properties of polynomials over finite fields. In this scheme, a polynomial of degree k−1 is constructed, where k is the threshold number of shares required to reconstruct the secret. The coefficients of the polynomial are randomly generated, with the constant term being the secret itself (in this case, the HMAC-generated key).

For each participant intended to hold a share, the polynomial is evaluated at different points (usually integers starting from 1 upwards). Each point and the corresponding polynomial value form a share. Only when k such points are known can the polynomial (and thus the secret) be reconstructed.

To ensure the security of the secret sharing scheme, the coefficients, aside from the constant term (the secret), are generated using a secure random number generator within the HRoT 123. This randomness is essential to prevent any predictability in the polynomial, which may jeopardize the security of the shares.

While the shares are distributed, the coefficients used to generate these shares are securely stored or immediately destroyed after share distribution, depending on the security policy enforced by the HRoT software. This ensures that no residual information is left that could be used to compromise the scheme.

The software responsible for implementing Shamir's Secret Sharing 151 within the HRoT 123 must perform several critical functions: generating the polynomial, evaluating it to produce shares, and handling the secure distribution and storage of these shares. The software operates within the secure boundaries established by the HRoT 123, utilizing its cryptographic capabilities for tasks such as random number generation and encryption of data before it is stored or transmitted. This integration ensures that all operations related to secret sharing adhere to the highest security standards. The software includes mechanisms for verifying the integrity and authenticity of shares during the reconstruction phase. This includes checks to ensure shares have not been altered and are submitted by authorized parties. It may use additional cryptographic techniques, such as digital signatures on each share, to provide this level of verification.

In systems requiring user interaction, such as enterprise security systems or consumer applications such as digital wallets, the HRoT software preferably provides a secure interface for users to manage their shares. This may include functionalities to back up shares securely, instructions for share recovery, and secure communication channels for share reconstruction requests.

When the requisite number of shares is collected, the software securely reconstructs the key by interpolating the polynomial at the collected points. This process is sensitive and is preferably handled within the secure environment to prevent exposure of the reconstructed key.

All activities related to secret sharing, including share generation, distribution, and key reconstruction, are logged and monitored. This not only helps in ensuring compliance with security policies but also in auditing the processes for any potential security breaches or irregularities.

By embedding Shamir's Secret Sharing 151 within the HRoT 123 and employing robust software mechanisms to manage the cryptographic operations securely, this method effectively shields sensitive cryptographic keys against both external threats and internal vulnerabilities. This significantly enhances the overall security posture of any system employing the technology.

In the next step, the key shares are distributed 111 across secure storage locations 161, with at least one share stored within the HRoT environment 115. The distribution of key shares 111 across secure storage locations 161 is an important step in ensuring the safety and availability of cryptographic keys in the event of partial data loss or attempts at unauthorized access. This step leverages a combination of hardware and software resources to effectively safeguard and manage the distribution process. This combination includes integrated secure modules. In particular, the HRoT 123 provides a physically and logically secure environment for the storage of sensitive data, including cryptographic key shares. This module is equipped with hardware-based security features such as a secure boot, encryption engines, and physical tamper resistance. Within the HRoT 123, key shares are preferably isolated from other data and processes running on the device. This isolation helps protect the key shares from software vulnerabilities and malware that might affect other parts of the system.

In some embodiments, key shares may be stored in encrypted cloud storage services that offer high availability and disaster recovery capabilities. These services typically use strong encryption protocols both at rest and in transit to ensure that key shares remain confidential and integral. Blockchain technology may be utilized for storing key shares as an added layer of security through decentralization. Each share may be stored as part of a blockchain ledger, making unauthorized alterations practically impossible due to the distributed nature of blockchain.

This combination also includes secure distribution software. This software preferably includes encryption mechanisms such that, prior to transmission, each key share is encrypted using robust cryptographic algorithms to ensure that it remains secure even if intercepted during transit. This typically involves asymmetric encryption, where each share is encrypted with the recipient's public key. The software uses secure communication protocols, such as HTTPS or secure socket layers, to transmit encrypted key shares to designated storage locations. This ensures that data integrity and privacy are maintained throughout the transmission process.

The software also implements software controls to manage who can access the key shares. This includes the use of authentication mechanisms, such as two-factor authentication, and authorization protocols to ensure that only authorized entities can access or handle the key shares. The distribution software also maintains detailed logs of all operations related to the key shares, including when and where each share was sent, who accessed it, and any attempts to modify or intercept the shares. This logging is crucial for regulatory compliance and for forensic analysis in the event of a security breach.

Various considerations may be taken into account in implementing the management and distribution of key shares. For example, the system is preferably scalable to handle varying numbers of key shares and storage locations, accommodating changes in organizational needs or security requirements. The distribution and storage system preferably has built-in redundancy to prevent data loss. This might include storing multiple copies of key shares in geographically dispersed locations to protect against site-specific disasters. The system should integrate seamlessly with existing security infrastructure, including identity and access management systems, to leverage established security policies and user management protocols. Secure interfaces for both users and administrators may be provided for managing key shares, including their creation, distribution, and recovery. These interfaces preferably provide ease of use while maintaining strict security controls. By carefully managing the distribution of key shares using a combination of advanced hardware and sophisticated software resources, organizations can ensure that cryptographic keys are both secure and readily available when needed, thus maintaining the integrity and security of their overall cryptographic infrastructure.

The key recovery process 113 involves a secure and robust methodology to reconstruct cryptographic keys using distributed and hardware-protected mechanisms. As previously noted, the system employs Shamir's Secret Sharing to divide the cryptographic key into multiple shares, with a threshold number required for reconstruction. During recovery, the key shares are retrieved from distributed secure storage locations via encrypted channels. This ensures the confidentiality and integrity of the shares during transmission.

To authorize the recovery process, the system relies on a multi-factor authentication mechanism that includes user biometric data, captured and securely processed through high-resolution biometric sensors, and a Personal Identification Number (PIN). Once authenticated 173, the retrieved key shares are decrypted and combined exclusively within a Hardware Root of Trust (HRoT) environment 171. This hardware-based secure module provides isolation from the main system and ensures that the reconstructed key remains inaccessible to unauthorized entities.

The reconstructed cryptographic key may then be securely utilized within the HRoT for cryptographic operations, such as encryption or authentication, without exposing it to external vulnerabilities. By integrating advanced cryptographic techniques, multi-factor authentication, and hardware-level security, the recovery process addresses challenges such as single points of failure and unauthorized access, ensuring a resilient and user-friendly approach to cryptographic key management.

The foregoing method provides a comprehensive, secure framework for cryptographic key management by integrating advanced hardware security modules (like HRoT and TRNG) with sophisticated cryptographic and secret sharing software. This approach ensures that all aspects of key generation, storage, distribution, and recovery are securely managed.

The systems and methodologies disclosed herein, and especially the disclosed Hardware Root of Trust (HRoT) system, may be further appreciated with respect to the following particular, non-limiting example of their implementation in the context of secure digital wallets for financial transactions. This application addresses key challenges such as cryptographic key security, recovery, and cross-device access. In this implementation, the HRoT system generates cryptographic keys using a True Random Number Generator (TRNG) integrated within the hardware. To ensure user-specific security, the keys are combined with multi-factor authentication inputs, including a user-defined PIN and biometric data (e.g., fingerprint or facial recognition), which are securely hashed. The resulting key is further encrypted using a Hash-Based Message Authentication Code (HMAC), ensuring integrity and irreversibility.

For resilience against device loss or failure, the system utilizes Shamir's Secret Sharing to split the HMAC-protected key into multiple shares, distributing them across secure locations. One share is stored within the HRoT on the user's device, while others can be stored in encrypted cloud storage, hardware security modules (HSMs), or hardware tokens. If the device is compromised or replaced, the system enables seamless key recovery through multi-factor authentication, combining biometric verification with PIN input to authorize the secure reconstruction of the key within the HRoT environment.

During financial transactions, the HRoT ensures that sensitive cryptographic operations, such as digital signing and data encryption, occur securely within the hardware's isolated environment. This prevents exposure of sensitive keys to external vulnerabilities, such as software-based attacks. Additionally, the system's ability to integrate post-quantum cryptographic algorithms, such as lattice-based schemes, future-proofs the security of the digital wallet against emerging threats from quantum computing.

This end use of the HRoT system is ideal for mobile banking applications, cryptocurrency wallets, and enterprise payment systems. It provides a robust solution that ensures resilient key recovery, secure cross-device portability, and protection against unauthorized access. By combining advanced cryptographic techniques with hardware-level security and multi-factor authentication, the system enhances both security and usability for users in high-risk, sensitive applications.

The systems and methodologies disclosed herein, and especially the disclosed Hardware Root of Trust (HRoT) system, may be further appreciated with respect to the following additional particular, non-limiting example of their implementation in providing secure authentication and access control for enterprise environments.

In large-scale organizations, safeguarding sensitive systems, data, and infrastructure against unauthorized access is critical. The HRoT system provides a robust framework for secure cryptographic key management, ensuring tamper-resistant access control mechanisms across enterprise networks. The methodology begins with cryptographic key generation within the HRoT, utilizing a True Random Number Generator (TRNG) for high-entropy, unpredictable key creation. To tie access credentials securely to authorized users, the keys are personalized using multi-factor authentication, including biometric data (e.g., fingerprints, facial recognition, or iris scans) and a user-defined PIN. The biometric data and PIN are combined and securely hashed, and the final key is encrypted using a Hash-Based Message Authentication Code (HMAC) to ensure integrity, confidentiality, and irreversibility.

The system uses Shamir's Secret Sharing to divide the HMAC-protected cryptographic key into multiple shares. These shares are stored across secure environments such as the HRoT, encrypted cloud storage, and hardware security modules (HSMs) distributed geographically. For high-security access control, the HRoT on user devices (e.g., laptops, mobile phones, or smartcards) securely retrieves and reconstructs the key using the shares, provided the user passes multi-factor authentication. This process ensures that the reconstructed key remains isolated within the HRoT, protecting it from external tampering or exposure.

When deployed for enterprise access control, the HRoT system can regulate access to sensitive systems, secure data centers, or restricted networks. For example, an employee accessing a company server would need to authenticate via biometric verification and PIN input, with the HRoT validating the user's credentials and enabling key reconstruction for secure session initiation. The HRoT then generates secure session keys for encryption and authentication processes, ensuring that the employee's access is encrypted end-to-end and resistant to interception.

In addition, the system supports cross-device interoperability. If an employee's device is compromised or replaced, the HRoT framework enables secure key recovery through multi-factor authentication, reconstructing the cryptographic key without compromising its security. This functionality simplifies device onboarding while maintaining the highest levels of protection.

The HRoT system can further incorporate post-quantum cryptographic algorithms to future-proof the access control framework against quantum computing threats. Additionally, tamper-evident mechanisms integrated into the HRoT ensure that any physical or logical tampering attempts trigger protective responses, such as key destruction or system lockdown, preventing unauthorized access.

This end use is particularly suited for securing enterprise networks, government infrastructure, and critical industrial systems, where robust authentication and access control are paramount. By leveraging HRoT, multi-factor authentication, and advanced cryptographic techniques, the methodology provides a scalable, resilient solution for ensuring secure access, mitigating the risks of unauthorized entry, and protecting sensitive enterprise assets.

Various improvements, substitutions or modifications may be made to the systems and methodologies disclosed herein without departing from the scope of the teachings herein.

For example, various cryptographic keys may be utilized in the systems and methodologies described herein, depending on the specific application and security requirements. Symmetric keys, such as those used in AES (Advanced Encryption Standard), are often ideal for efficient encryption and decryption, ensuring data confidentiality in high-speed operations. For scenarios requiring strong authentication and non-repudiation, asymmetric keys like RSA or ECC (Elliptic Curve Cryptography) may be employed, particularly for secure key exchanges and digital signatures.

Keys generated using True Random Number Generators (TRNGs) integrated into the HRoT environment provide high entropy and unpredictability, making them robust against cryptographic attacks. These TRNG-generated keys may be further combined with user-specific data, such as biometric hashes and PINs, to create composite keys uniquely tied to individual users, enhancing authentication security. Additionally, keys derived through Hash-Based Message Authentication Code (HMAC) operations provide tamper resistance and integrity assurance by securely combining multiple inputs like TRNG outputs and user-specific identifiers.

To ensure secure communication, session keys may be generated for temporary use, providing confidentiality for transient operations and minimizing security risks by being destroyed after use. The systems and methodlogies disclosed herein also preferably incorporate Shamir's Secret Sharing to split keys into multiple shares stored across secure locations, requiring a threshold number of shares to reconstruct the original key. This approach enhances resilience against data loss or unauthorized access.

In some embodiments, quantum-resistant cryptographic keys may be utilized, such as those based on lattice cryptography (e.g., Kyber or Dilithium) or hash-based schemes (e.g., SPHINCS+). These keys ensure long-term security against attacks from quantum computers. During transitional phases, hybrid cryptographic keys combining traditional algorithms (e.g., RSA or ECC) with quantum-resistant methods may be employed to maintain compatibility and enhance security. In decentralized storage scenarios, blockchain-associated keys may be utilized for the secure storage and verification of key shares, leveraging the immutability and transparency of blockchain technology.

Finally, device-specific root keys embedded within the HRoT serve as foundational trust anchors for generating and managing other cryptographic keys, ensuring a hardware-level baseline for secure operations. By employing a combination of these cryptographic keys, the system offers flexibility, scalability, and robust protection for a wide range of applications, from secure data management to distributed key recovery.

The systems and methodologies described herein may incorporate a variety of True Random Number Generators (TRNGs), and these TRNGs may leverage diverse physical phenomena to achieve high entropy and unpredictability. In some embodiments, electronic noise-based TRNGs may be utilized. These TRNGs derive randomness from thermal noise (Johnson-Nyquist noise) or shot noise in electronic circuits. Similarly, oscillator-based TRNGs may be utilized exploit phase jitter or frequency instability in free-running oscillators, while ring oscillator-based TRNGs may be utilized that specifically use timing jitter in a feedback loop of inverters. These types of TRNGs are particularly suited for hardware systems due to their efficiency and ease of integration.

Photon-based TRNGs provide another highly secure option, relying on quantum mechanical phenomena such as photon emission or measurement outcomes. For example, the arrival times of photons or binary results from quantum superposition offer excellent sources of randomness. Other quantum-inspired techniques which may be utilized in the systems and methodologies disclosed herein include radioactive decay-based TRNGs, which generate random numbers from the fundamentally unpredictable nature of radioactive decay, and quantum tunneling-based TRNGs, where electrons passing through barriers create high-quality entropy.

In addition, thermal diffusion-based TRNGs and magnetic field fluctuation TRNGs may be utilized systems and methodologies described herein. These TRNGs utilize physical processes like particle motion in thermal environments or magnetic noise to generate randomness. Chaotic system-based TRNGs, which depend on the unpredictability of non-linear systems, and avalanche diode-based TRNGs, leveraging noise from semiconductors operating in breakdown mode, are also possible options for generating secure random numbers. More advanced designs include spintronic TRNGs, which rely on variations in spin-based phenomena like spin transfer torque, and hybrid TRNGs, which combine multiple entropy sources (e.g., thermal noise and jitter) to enhance robustness against external interference.

The choice of TRNG in the systems and methodologies described herein depends on the specific application's security needs, hardware constraints, and environmental conditions. By integrating suitable TRNGs into the Hardware Root of Trust (HRoT), the system ensures secure and high-quality random number generation, crucial for reliable cryptographic operations. This flexibility allows the system to cater to a wide range of security requirements while maintaining robust protection against potential vulnerabilities.

The systems and methodologies described herein may utilize a variety of biometric hashes derived from a user's unique biometric data to ensure secure and privacy-preserving authentication. Fingerprint hashes are a preferable choice, and may be created by extracting and hashing the distinctive ridge patterns and minutiae points on a user's fingerprint. Similarly, facial recognition hashes may be utilized. These hashes are generated from key facial features, such as the distance between eyes, nose, and mouth, which are converted into secure cryptographic representations. Iris or retinal hashes offer another robust option, leveraging the intricate and stable patterns in the user's iris or retinal blood vessels for high-security applications.

Voice hashes, derived from the unique characteristics of a user's speech, including tone, pitch, and cadence, provide a non-invasive alternative. Other physical features, such as hand geometry or vein patterns, can also be hashed to create secure identifiers. Hand geometry hashes utilize measurements like finger lengths and palm width, while vein pattern hashes are created from near-infrared imaging of subcutaneous vein structures, ensuring a high level of uniqueness and security.

Some embodiments of the systems and methodologies described herein may utilize behavioral biometric hashes, which analyze patterns in user actions such as typing rhythm, gait, or touchscreen interactions. These dynamic features may be particularly useful in continuous authentication scenarios. Additionally, multimodal biometric hashes may be utilized which combine multiple types of biometric data, such as fingerprint and iris features, to create a composite hash that enhances security and reduces the likelihood of false positives or negatives. For ultimate flexibility, template protection methods may be used, allowing biometric data to be hashed in a way that enables secure updates or revocation if compromised.

By hashing biometric data within a secure Hardware Root of Trust (HRoT), these systems ensure that raw biometric information is never exposed, preserving user privacy while enabling robust, high-security authentication. The choice of biometric hash depends on the specific application requirements, balancing usability, accuracy, and security.

In the systems and methodologies described herein, a cryptographic key generated using a True Random Number Generator (TRNG) may be combined with a user-defined PIN and a biometric hash of the user's biometric data in several secure and sophisticated ways. One preferred method involves concatenation and hashing, where the TRNG-generated key, PIN, and biometric hash are combined into a single data stream and processed through a cryptographic hash function such as SHA-256. This produces a unique, fixed-length composite key that blends randomness from the TRNG with user-specific inputs. Alternatively, a Hash-Based Message Authentication Code (HMAC) can be employed, where the TRNG key acts as the cryptographic secret, and the PIN and biometric hash serve as inputs. This approach ensures that the resulting key is tamper-resistant, irreversible, and tied to the user's specific credentials.

Another possible method utilizes bitwise XOR operations to combine the TRNG key, PIN, and biometric hash. The XOR operation blends the inputs at the binary level, creating a unique and difficult-to-reconstruct composite key. Similarly, a Key Derivation Function (KDF), such as PBKDF2, bcrypt, or HKDF, can securely process the TRNG key, PIN, and biometric hash, often with the addition of cryptographic salt. This approach enhances security by increasing computational complexity, making brute-force attacks more challenging. For additional layers of protection, the TRNG key may also be used to encrypt the user's biometric hash and PIN using symmetric encryption algorithms such as AES, with the encrypted output further processed to generate the final cryptographic key.

Additional methods include multi-layered hashing and polynomial interpolation. In multi-layered hashing, inputs are combined sequentially through multiple hashing stages, such as hashing the TRNG key with the PIN first, and then with the biometric hash. Polynomial interpolation techniques, such as Shamir's Secret Sharing, can treat each input as coefficients of a polynomial, creating shares that must be combined to reconstruct the final key. This threshold-based approach ensures that all components (TRNG key, PIN, and biometric hash) are required for key recovery, enhancing security.

Other techniques involve salting and hashing, where the user PIN and biometric hash act as cryptographic salt to the TRNG key, ensuring uniqueness even when the TRNG generates identical outputs. For systems requiring both confidentiality and integrity, authenticated encryption schemes such as AES-GCM or ChaCha20-Poly1305 may use the TRNG-generated key to encrypt the biometric hash and PIN securely. Finally, portions of the TRNG key, PIN, and biometric hash may be split and combined using threshold-based integration, where only a defined number of shares are required to reconstruct the final key.

By leveraging these methods, the systems and methodologies disclosed herein may achieve a high level of cryptographic strength, personalization, and resilience. Combining the randomness of a TRNG with user-specific inputs such as a PIN and biometric hash ensures that the resulting cryptographic key is unique, secure, and tied to both the hardware-generated randomness and the authorized user. This approach makes the system well-suited for secure authentication, encryption, and key management applications while providing robust protection against unauthorized access and attacks.

The systems and methodologies described herein may leverage various techniques to encrypt a combined key (including a TRNG-generated key, a user PIN, and a biometric hash) using a Hash-Based Message Authentication Code (HMAC) operation. This encryption ensures that the key is cryptographically secure, tamper-resistant, and irreversible. One preferred approach involves processing the combined key through an HMAC operation with a strong cryptographic hash function, such as SHA-256 or SHA-3. The HMAC's dual hash process (inner and outer hashes) securely integrates the input with a secret key, ensuring resistance to unauthorized modifications.

Additional methods may be utilized to enhance the security of the HMAC process. For example, layered HMAC applies separate HMAC operations to individual components (e.g., TRNG key with PIN, followed by biometric hash), ensuring complexity and added security. Similarly, salting the input with unique cryptographic values like device identifiers or timestamps ensures that even identical inputs yield distinct keys. To further strengthen the operation, the HMAC secret key itself can be dynamically generated using a TRNG or device-specific entropy, tying the encryption process to a specific device or session.

Some embodiments may utilize techniques with nested HMAC operations, where the initial HMAC output is processed through a second HMAC using a different secret key or hash function, providing layered protection against attacks. Masking sensitive inputs, such as the PIN or biometric hash, before applying HMAC adds another layer of obfuscation, ensuring even intermediate data remains protected. The system may also partition the combined key into segments, separately hashing each part and combining the individual HMAC outputs to produce the final irreversible key.

Further enhancements may involve HMAC with key expansion, where the HMAC output is processed through a Key Derivation Function (KDF) to generate additional keys for encryption, signing, or authentication. One-time HMAC keys ensure that the secret keys used in the HMAC operation are unique to each session, preventing reuse or exploitation in future operations. Finally, the HMAC process may incorporate metadata, such as user IDs or session tokens, ensuring the resulting key is context-specific and bound to authentication parameters.

By employing these HMAC-based encryption techniques, the system transforms the combined key into a robust, irreversible cryptographic artifact. These approaches not only safeguard sensitive data but also enable secure key management and authentication processes, reinforcing the overall integrity of the cryptographic framework.

In the systems and methodologies disclosed herein, various permutations and modifications may be made to the step of using Shamir's Secret Sharing to divide the HMAC-generated key into multiple shares, where a threshold number of shares is required for reconstruction. These variations may be designed, for example, to address security, usability, or implementation requirements.

For example, in some embodiments, alternative secret sharing schemes can be employed, such as verifiable secret sharing (e.g., Pedersen's scheme) to ensure shares remain valid and untampered, or Blakley's Secret Sharing, which uses geometric methods such as intersecting hyperplanes. Additionally, dynamic thresholding allows the number of required shares to adapt based on security policies, with higher thresholds enforced during high-risk conditions. In some embodiments, hierarchical secret sharing may be utilized. This introduces multi-tiered schemes, where shares are distributed among different roles, such as devices and trusted custodians, requiring multi-tier cooperation for reconstruction.

To enhance security further, shares may be protected using multi-factor recovery, where additional authentication steps, such as biometric verification or hardware-based access controls, are required before retrieving and reconstructing shares. This may be paired with encrypted key shares, where individual shares are encrypted with device-specific keys, ensuring an extra layer of confidentiality during storage and distribution.

Possible variations also include partial key reconstruction, where systems employ error correction techniques such as Reed-Solomon codes to enable recovery even with missing or corrupted shares, ensuring resilience in disaster scenarios. Similarly, shares may be distributed to decentralized or blockchain-based storage networks, such as IPFS or a blockchain ledger, thereby ensuring traceability, integrity, and redundancy. Time-locked reconstruction may be employed to further restrict access to the key, allowing it to be reconstructed only after specific conditions, such as a time delay or event trigger, have been met.

To further improve privacy and robustness, hybrid approaches may combine Shamir's Secret Sharing with techniques such as threshold homomorphic encryption or multi-party computation (MPC). Each key share may also be digitally signed or validated using cryptographic checksums to guarantee its authenticity and integrity before use. Furthermore, shares may be stored in tamper-resistant environments such as Trusted Execution Environments (TEEs) or secure Hardware Root of Trust (HRoT) modules, which protect against external tampering and ensure availability.

By incorporating or combining the foregoing variations, the systems and methodologies may improve their resilience, flexibility, and security. These enhancements ensure that key management and recovery processes remain robust, even under extreme conditions, while maintaining usability for applications requiring distributed, secure, and tamper-resistant cryptographic key protection.

In the systems and methodologies disclosed herein, various permutations and modifications may be made to the step of distributing the key shares across secure storage locations (with at least one share stored within the HRoT environment) to enhance security, flexibility, and operational efficiency, or to achieve other benefits. One preferred approach involves leveraging diverse storage mediums, such as decentralized networks (e.g., blockchain or IPFS), hybrid cloud and on-premises systems, or geographically distributed Hardware Security Modules (HSMs). These methods ensure redundancy and availability while protecting against localized failures or attacks. Shares may also be stored redundantly, with duplicates kept in multiple secure locations to safeguard against data loss.

Enhanced use of the HRoT environment may include storing shares across multiple HRoT instances on separate devices, allowing distributed reconstruction while retaining hardware-level protection. Alternatively, the HRoT-stored share may act as a critical anchor, requiring its presence for any reconstruction attempt. To secure the distribution process, shares may be encrypted during transit using end-to-end encryption protocols such as TLS or AES-GCM, or with public key encryption tied to the destination storage.

Role-based and hierarchical distribution strategies may be utilized to assign shares based on user roles, such as administrators or custodians, with multi-tiered access policies, thus ensuring that only authorized parties can retrieve shares. Dynamic and context-aware approaches may be employed to adjust share distribution based on factors such as threat levels or operational environments, periodically reallocating shares to new locations to reduce risk. Shares may also be stored with advanced cryptographic techniques, such as fragmentation with error correction, thereby enabling reconstruction even if some shares are lost or corrupted.

Secure retrieval protocols may be utilized to enhance protection further by requiring multi-factor authentication or device attestation to access shares. Tamper-evident storage environments, Trusted Execution Environments (TEEs), and immutable audit logs may be leveraged to ensure that unauthorized access attempts are detectable, and shares remain traceable. Geofencing or time-limited accessibility may impose additional restrictions, allowing retrieval only under specific conditions.

By incorporating the foregoing variations, the systems and methodologies disclosed herein may achieve robust and adaptable key management. These enhancements ensure secure distribution and storage of key shares, catering to diverse operational requirements while protecting against unauthorized access and ensuring seamless recovery capabilities.

In some embodiments of the systems and methodologies disclosed herein, various modifications may be made to the step of implementing a recovery mechanism by which the stored key shares may be retrieved, decrypted, and combined within the HRoT to reconstruct the original cryptographic key. One possible variation involves introducing multi-factor authentication (MFA) during key recovery, requiring a combination of credentials such as biometrics, PINs, device attestation, or one-time passwords (OTPs). This ensures that only authorized users can trigger the recovery process. Additionally, adaptive thresholds may be implemented, where the number of required key shares increases based on security conditions, such as suspicious activity or unfamiliar locations.

To protect key shares during retrieval, they can be encrypted individually using asymmetric encryption, such as RSA or ECC, ensuring they are only decrypted securely within the HRoT. Authenticated encryption schemes such as AES-GCM may further ensure the integrity and confidentiality of the shares during transmission. In more advanced implementations, context-aware recovery mechanisms may restrict the reconstruction process based on specific triggers, such as geofencing, time delays, or device usage history, adding a layer of environmental security. Similarly, time-locked recovery may delay key reconstruction to allow administrators to detect and respond to malicious attempts.

The recovery process may also be enhanced through secure execution environments. For example, combining the HRoT with a Trusted Execution Environment (TEE) creates an isolated and tamper-resistant space for key reconstruction. Shares may also be stored in tamper-evident modules, where any unauthorized access attempts result in alerts or data self-destruction. For added resilience, distributed reconstruction across multiple HRoT instances or decentralized systems, such as blockchain-based verification, may ensure shares are validated collaboratively before being combined. This eliminates single points of failure and introduces tamper-proof auditing.

In enterprise or multi-user systems, approval-based workflows may be utilized which require validation from multiple custodians or administrators before the recovery is allowed. This may be paired with immutable logging of all recovery operations, capturing details such as user IDs, timestamps, and device information for forensic analysis. Notification systems may further alert users or administrators about recovery attempts to detect potential unauthorized activity. Finally, features such as self-destruct mechanisms may securely erase key shares after a defined number of failed authentication attempts or suspicious behavior, thus ensuring protection against brute-force attacks.

The foregoing variations may be utilized to create a highly flexible and robust recovery mechanism that aligns with diverse security and operational needs. By combining multi-factor authentication, encrypted share retrieval, distributed validation, and secure execution environments, systems and methodologies incorporating these features help to ensure that cryptographic key recovery remains resistant to unauthorized access while offering strong resilience, usability, and traceability.

Some embodiments of the systems and methodologies described herein may be enhanced through the integration of post-quantum cryptographic (PQC) algorithms to address emerging threats posed by quantum computing. Quantum algorithms, such as Shor's algorithm, have the potential to compromise widely used cryptographic methods such as RSA and ECC, which rely on the difficulty of factoring large numbers or solving discrete logarithm problems. To future-proof the system against these threats, PQC algorithms that are resistant to both classical and quantum attacks may be incorporated as replacements or supplements to existing cryptographic operations.

One approach involves the adoption of lattice-based cryptography, which underpins quantum-resistant schemes like Kyber (for key encapsulation) and Dilithium (for digital signatures). Lattice-based schemes rely on the computational hardness of lattice problems, such as the Shortest Vector Problem (SVP) or Learning With Errors (LWE), making them well-suited for securing keys in a post-quantum environment. Additionally, hash-based cryptography, including Merkle tree-based signature schemes such as SPHINCS+, offers quantum-resistant digital signatures by leveraging the inherent strength of hash functions, which remain robust even in the presence of quantum computational capabilities.

To facilitate a smooth transition, a hybrid cryptographic approach may be employed where existing methods, such as HMAC-based encryption, coexist with PQC algorithms. For example, during key generation or reconstruction processes, both classical cryptographic methods and PQC algorithms can be applied in parallel. This ensures backward compatibility while gradually introducing quantum-resistant features, maintaining security for current applications while preparing for future advancements.

Furthermore, the integration of PQC algorithms may be extended to Shamir's Secret Sharing for distributing key shares securely. The shares may be encrypted or signed using quantum-resistant schemes to ensure they remain secure against future quantum attacks. For critical operations, such as key recovery or reconstruction within the Hardware Root of Trust (HRoT), post-quantum algorithms may safeguard the process, ensuring that the reconstructed key remains resilient even in a quantum-enabled threat landscape.

By integrating post-quantum cryptographic algorithms, the system may ensure long-term data protection, secure distributed storage, and robust key management. This proactive approach future-proofs the cryptographic framework against quantum computing advancements while maintaining the integrity, reliability, and security of the system across diverse applications.

Some embodiments of the systems and methodologies described herein may incorporate a Dynamic Key Regeneration Protocol to further enhance the security and resilience of cryptographic key management. This protocol ensures that cryptographic keys are periodically regenerated within the Hardware Root of Trust (HRoT) using a True Random Number Generator (TRNG), thereby reducing the risk of long-term key exposure and mitigating potential vulnerabilities that arise from prolonged use of a single key. By introducing periodic regeneration, the system minimizes the risk of compromise due to key leakage, cryptographic attacks, or emerging security threats.

The regeneration process may be triggered based on predefined usage thresholds, time intervals, or specific security events, such as detected anomalies, unauthorized access attempts, or suspected tampering. For example, if the HRoT monitoring mechanisms identify irregular access patterns or potential breaches, the system may proactively trigger key regeneration to replace the compromised key without impacting normal operations. Additionally, usage-based triggers may be defined, such as regenerating the key after a specified number of encryption or authentication operations to prevent overuse and potential cryptographic weaknesses.

To maintain system continuity during regeneration, the protocol may employ a key rollover mechanism, wherein the new cryptographic key is generated and securely distributed using Shamir's Secret Sharing or other secure distribution techniques. The previous key remains temporarily active during the transition, allowing ongoing processes to complete securely before the new key takes effect. This ensures seamless migration and avoids service interruptions. The regenerated key shares are redistributed across secure storage locations, with at least one share stored within the HRoT environment to maintain robust protection.

For added security, the regeneration process may involve dynamic re-randomization of entropy using the TRNG integrated into the HRoT. The regenerated key may further incorporate updated user-specific inputs, such as biometric data and a PIN, thus ensuring that the new key remains personalized and resistant to replay attacks. This approach enhances the cryptographic strength of the system, making it resilient to long-term cryptanalysis and future vulnerabilities.

By implementing the Dynamic Key Regeneration Protocol, the system may achieve a higher level of adaptability and security, thereby ensuring that cryptographic keys remain robust, fresh, and resilient against evolving threats. This feature is particularly beneficial for long-term data protection, secure distributed key management, and critical applications where key integrity and operational security are paramount.

The systems and methodologies described herein may further incorporate Tamper-Evident Secure Modules to enhance the security and integrity of cryptographic key management and storage. These modules are designed to detect, respond to, and mitigate physical or environmental tampering attempts, ensuring the protection of cryptographic keys and sensitive data within the Hardware Root of Trust (HRoT) framework. Tamper-evident mechanisms provide an important layer of defense by not only protecting against unauthorized access but also enabling real-time alerts and secure responses when a breach is detected.

The tamper-evident modules may include physical tamper detection features, such as conductive mesh shields, temperature sensors, and voltage monitoring circuits. For instance, any attempt to physically probe or manipulate the module, such as drilling or exposing it to extreme environmental conditions (e.g., temperature or voltage anomalies), triggers a tamper response. This response may include securely erasing sensitive data, including cryptographic keys, or rendering the module inoperable to prevent further compromise.

Additionally, the modules can incorporate tamper detection logic to monitor for logical and side-channel attacks, such as power analysis, electromagnetic probing, or clock manipulation. Advanced sensors and detection circuits may identify anomalies in the module's operation, such as unexpected timing variations, irregular power consumption, or electromagnetic interference. Upon detection of such anomalies, the system may initiate protective measures, including data encryption, lockdown of cryptographic operations, or generation of secure alerts for administrative review.

To further enhance resilience, real-time tamper response mechanisms can be implemented. For example, upon detecting physical intrusion, the module may immediately trigger secure self-destruction protocols that zeroize or overwrite sensitive cryptographic material stored within the HRoT. Additionally, secure alerts may be sent to authorized users or system administrators through encrypted communication channels, providing real-time notifications of potential breaches for further investigation and remediation.

The tamper-evident modules may also support audit and monitoring functionalities, logging all tamper events, attempted breaches, and associated responses. These logs may be stored securely within the HRoT or external tamper-proof storage systems, such as blockchain-based audit ledgers, to provide immutable evidence for forensic analysis and regulatory compliance.

By integrating Tamper-Evident Secure Modules, these systems and methodologies may achieve robust protection against physical and environmental attacks, ensuring the integrity and confidentiality of cryptographic keys and sensitive data. This feature is particularly beneficial for applications requiring a high level of security, such as financial services, digital identity systems, IoT devices, and government communications, where resistance to physical compromise and secure response mechanisms are critical.

Some embodiments of the systems and methodologies described herein may incorporate adaptive authentication mechanisms to dynamically adjust security measures based on contextual factors, ensuring both robust protection and enhanced usability. These mechanisms intelligently assess the risk level associated with each authentication attempt and adapt the required authentication methods accordingly. By combining user behavior analysis, device context, and transaction-specific parameters, the system may achieve a suitable balance between security and user convenience.

For example, during low-risk operations, such as accessing non-sensitive data or performing small transactions, the system may require minimal authentication, such as a Personal Identification Number (PIN). However, for high-risk activities, such as accessing critical systems, transferring large amounts of data, or operating from an unfamiliar location or device, the system may escalate the authentication requirements. In such cases, multi-factor authentication (MFA) may be enforced, including the use of biometric verification (e.g., fingerprints, facial recognition, or voice recognition) in combination with secure PIN input.

The adaptive mechanisms may also utilize behavioral biometrics to continuously monitor user interactions, such as typing speed, touchscreen gestures, or device usage patterns. If anomalies are detected (such as, for example, deviations from established user behavior), the system may automatically enforce stricter authentication measures or trigger security alerts. Additionally, contextual factors such as device location (via GPS or IP-based geolocation), network conditions (e.g., trusted versus public networks), and time-based parameters (e.g., unusual login times) may influence the authentication process, further enhancing situational security.

These mechanisms may be implemented within the Hardware Root of Trust (HRoT) environment to ensure that all authentication data and processes remain secure and isolated from external threats. The HRoT may securely process biometric inputs and behavioral data, generating cryptographic challenges or session keys to validate user identity without exposing sensitive information. Furthermore, real-time monitoring and risk scoring algorithms may be integrated into the HRoT to assess the overall security risk and dynamically adjust authentication requirements on the fly.

By implementing Adaptive Authentication Mechanisms, the system provides a flexible, context-aware approach to user authentication. This not only enhances security by addressing potential threats proactively but also improves usability by minimizing friction for legitimate users during low-risk operations. Such adaptive systems are particularly beneficial in applications involving financial transactions, digital identity management, and IoT device authentication, where both security and user experience are paramount.

Some embodiments of the systems and methodologies described herein may incorporate cross-platform interoperability to enable seamless integration of the cryptographic framework across a diverse range of devices, operating systems, and applications. This feature ensures that the cryptographic key management, storage, and recovery mechanisms function consistently and securely within heterogeneous environments, thereby enhancing usability and scalability without compromising security.

To achieve cross-platform interoperability, these embodiments may leverage standardized Application Programming Interfaces (APIs) and communication protocols. These APIs enable secure interactions between the Hardware Root of Trust (HRoT) and various devices including, for example, smartphones, tablets, IoT devices, and enterprise servers. By using widely accepted standards, such as TLS for secure communication and platform-agnostic cryptographic libraries (for example, OpenSSL or Libsodium), the system ensures compatibility with different operating systems such as Android, iOS, Windows, Linux, and embedded platforms.

The HRoT may further support platform-specific modules that abstract hardware and software differences, ensuring that key generation, distribution, and recovery processes remain secure and consistent across devices. For example, on mobile platforms, the system may utilize Trusted Execution Environments (TEEs) such as Android KeyStore or Apple Secure Enclave for local storage and processing, while on enterprise or IoT systems, it may interface with hardware security modules (HSMs) or secure co-processors.

Additionally, cross-platform support may include the use of containerized environments or secure virtualization to isolate cryptographic operations on platforms that lack dedicated hardware security features. This approach allows cryptographic functions to run securely within a software-based trusted execution layer while maintaining compatibility with the HRoT architecture. For cloud and distributed environments, secure APIs can facilitate key share distribution and retrieval processes while maintaining interoperability with decentralized systems, such as blockchain or cloud-based storage platforms.

By enabling Cross-Platform Interoperability, the system ensures that organizations and users can securely manage cryptographic keys across multiple devices and ecosystems without being constrained by platform-specific limitations. This feature is particularly beneficial in environments where users require consistent security across devices, such as digital wallets, multi-device authentication, IoT networks, and enterprise-level secure communication systems. It allows for broad adoption, scalability, and flexibility while maintaining the high standards of security provided by the HRoT framework.

The systems and methodologies described herein may incorporate a user-friendly recovery interface to simplify and streamline the cryptographic key recovery process for end-users while maintaining the highest levels of security. This feature is designed to address usability challenges often associated with key recovery systems, particularly for users without technical expertise, ensuring that secure recovery mechanisms remain accessible and intuitive.

The recovery interface may provide guided workflows that walk users through the key recovery process step by step. These workflows may include visual aids, such as progress indicators and tooltips, to help users understand and complete recovery tasks with ease. For example, users may be prompted to verify their identity using a combination of biometric data (for example, fingerprint, retinal scan or facial recognition) and a Personal Identification Number (PIN), with clear on-screen instructions for each step. The interface may also include real-time feedback, such as success confirmations, error messages, and recovery progress notifications, to ensure a smooth user experience.

To further enhance usability, the system may support secure backup options for cryptographic key shares. The interface may guide users in securely storing their shares in designated locations, such as encrypted cloud services, hardware tokens, or offline storage devices. Additionally, recovery options may include integration with decentralized storage systems or custodial services, providing users with redundancy while ensuring their shares remain protected. The recovery interface can include secure retrieval mechanisms, such as QR codes, encrypted share downloads, or secure links, which allow users to access distributed shares conveniently while maintaining confidentiality.

For enhanced accessibility, the recovery interface may be designed to function across multiple platforms, including mobile devices, desktop systems, and web-based applications. By incorporating context-aware prompts, the interface may adapt to specific user scenarios, such as providing tailored instructions based on the user's device, location, or network conditions. Furthermore, additional features like multi-language support and accessibility tools (for example, screen readers, enlarged text, or voice commands) may be integrated to ensure inclusivity for a diverse range of users.

By implementing a User-Friendly Recovery Interface, the system helps to ensure that even non-technical users can manage key recovery processes securely and efficiently. This not only enhances the overall user experience but also reduces the likelihood of errors or data loss during key recovery. The intuitive design, combined with robust security measures, makes the system accessible for applications such as digital wallets, enterprise security platforms, and consumer-facing authentication systems, where ease of use is critical.

Some embodiments of the systems and methodologies described herein may incorporate a multi-location key distribution strategy to enhance fault tolerance, security, and resilience in the storage and management of cryptographic key shares. By distributing key shares across multiple secure and geographically diverse storage locations, the system ensures robust protection against localized risks, such as hardware failures, natural disasters, or targeted attacks, while maintaining availability for authorized recovery processes.

In one such embodiment, key shares generated using Shamir's Secret Sharing or similar threshold-based mechanisms are encrypted and distributed to a combination of secure storage environments. These environments may include on-device Hardware Root of Trust (HRoT) modules, cloud-based encrypted vaults, secure hardware security modules (HSMs), and decentralized systems such as blockchain networks. By leveraging a hybrid approach, the system balances redundancy and accessibility while maintaining strict security controls. For example, one share may reside within the HRoT of a user device, another in an encrypted cloud storage platform, and a third on a blockchain ledger. Each storage location is cryptographically protected, ensuring confidentiality and integrity during storage and retrieval.

To further strengthen resilience, the system may implement geographical distribution of shares across data centers or secure locations in different regions. This strategy mitigates risks from localized disruptions, such as power outages, data center breaches, or physical tampering. Shares stored in geographically distinct locations may only be retrieved and combined upon successful user authentication, ensuring that even if some shares are compromised or inaccessible, the cryptographic key remains protected.

Additionally, the system may incorporate redundant storage techniques to prevent data loss. For instance, duplicate copies of key shares may be encrypted and stored across multiple storage nodes, with secure synchronization mechanisms ensuring consistency. This redundancy provides an added layer of fault tolerance, enabling key recovery even in the event of partial share loss or corruption. Access to these shares may be governed by strict authorization protocols and secure communication channels to prevent unauthorized retrieval or tampering.

By employing a multi-location key distribution strategy, the system achieves a high level of security, fault tolerance, and resilience in managing cryptographic keys. This approach is particularly advantageous for mission-critical applications, such as financial systems, enterprise security infrastructures, and distributed IoT networks, where ensuring both data availability and confidentiality is paramount.

Some embodiments of the systems and methodologies described herein may incorporate backup mechanisms for biometric data to ensure the secure recovery and continuity of cryptographic operations in the event of biometric data loss, corruption, or device failure. Biometric data (such as, for example, fingerprints, facial scans, or iris patterns) plays a critical role in multi-factor authentication processes and cryptographic key generation. However, the loss or corruption of such data, whether due to hardware failures, accidental deletion, or environmental factors, may impede user authentication and key recovery. To address this challenge, the system provides secure, encrypted backup mechanisms for biometric templates, ensuring reliable access without compromising user privacy or security.

In one such embodiment, biometric data backups are stored in encrypted form using advanced cryptographic techniques, such as symmetric encryption (e.g., AES-GCM) or hash-based encryption schemes, ensuring that the raw biometric data remains inaccessible to unauthorized entities. These backups may be securely stored in distributed locations, including the Hardware Root of Trust (HRoT), trusted cloud storage services, or offline hardware tokens. Each backup may be further protected with multi-factor access controls, requiring both user authentication (e.g., PIN or password) and secure device validation for retrieval, thereby preventing unauthorized recovery attempts.

To enhance resilience, the system may utilize template protection mechanisms, such as cancelable biometrics or fuzzy cryptography, which transform biometric templates into non-reversible, secure representations. This ensures that even if a backup is compromised, the original biometric data cannot be reconstructed. Additionally, the system may integrate redundant storage strategies by creating encrypted backups in multiple secure locations, providing fault tolerance and mitigating risks from data loss or localized failures.

For user-friendly recovery, the system may incorporate an intuitive backup management interface that guides users through secure biometric data recovery processes. This interface may include step-by-step instructions for restoring backups, verifying data integrity, and re-enrolling biometric inputs when necessary. Real-time validation mechanisms ensure that restored biometric templates are consistent with the user's most recent enrollment, preventing unauthorized or mismatched recoveries.

By implementing Backup Mechanisms for Biometric Data, the system ensures that biometric authentication remains reliable, secure, and resilient against failures or data corruption. This approach is particularly beneficial in applications such as digital identity systems, secure financial transactions, and enterprise authentication platforms, where uninterrupted access and robust protection of biometric data are critical.

Some embodiments of the systems and methodologies described herein may incorporate efficient polynomial interpolation algorithms to optimize the reconstruction of cryptographic keys using threshold-based secret sharing techniques, such as Shamir's Secret Sharing. Polynomial interpolation serves as the foundation for reconstructing the original cryptographic key from a threshold number of key shares. To enhance performance and scalability, particularly in resource-constrained environments or distributed systems, these systems and methodologies may employ optimized algorithms that reduce computational overhead and improve efficiency during the interpolation process.

In one such embodiment, the system utilizes Lagrange interpolation for reconstructing the secret key, while implementing computational optimizations to minimize the number of operations required. These optimizations may include pre-computation of Lagrange basis polynomials, caching intermediate results, and leveraging finite field arithmetic to perform modular operations efficiently. Such enhancements reduce the computational complexity, enabling faster key reconstruction without compromising accuracy or security.

To further improve efficiency, the system may integrate FFT-based (Fast Fourier Transform) polynomial interpolation techniques, which allow for parallel processing of polynomial coefficients. By leveraging FFT, the system may accelerate the evaluation and interpolation of polynomials, particularly for large-scale cryptographic keys with higher thresholds and share counts. This approach may be especially advantageous in distributed environments where shares are retrieved from multiple secure locations, as it enables rapid reconstruction while maintaining consistent performance.

In addition, the system may incorporate adaptive interpolation algorithms that dynamically adjust computational strategies based on the available hardware resources and operational conditions. For instance, resource-constrained devices such as IoT systems may employ lightweight algorithms with reduced memory and processing requirements, while more powerful hardware environments may leverage parallelized or hardware-accelerated interpolation methods. The interpolation process may also integrate error detection and correction mechanisms to validate shares and ensure the integrity of the reconstructed polynomial, mitigating risks from corrupted or tampered key shares.

By implementing efficient polynomial interpolation algorithms, the system may achieve faster and more reliable cryptographic key reconstruction, making it suitable for real-time applications, distributed systems, and resource-limited environments. This optimization helps to ensure seamless recovery processes while maintaining the robustness and security of threshold-based key management methodologies, providing critical advantages for secure communications, enterprise systems, and decentralized cryptographic infrastructures.

Some embodiments of the systems and methodologies described herein may incorporate low-power hardware integration to optimize cryptographic operations for energy-efficient performance, particularly in resource-constrained environments such as IoT devices, mobile platforms, and edge computing systems. Given the increasing demand for secure key management and cryptographic processing in low-power devices, the system leverages specialized hardware components and optimized algorithms to minimize energy consumption while maintaining robust security and performance.

In one such embodiment, the system integrates hardware accelerators specifically designed for cryptographic functions such as encryption, decryption, key generation, and polynomial interpolation. These accelerators offload computationally intensive tasks from the primary processor, reducing energy consumption and improving efficiency. For example, low-power ASICs (Application-Specific Integrated Circuits) or FPGA (Field-Programmable Gate Array) implementations may perform cryptographic operations, such as AES encryption or Shamir's Secret Sharing, with minimal power usage. Additionally, the system may incorporate hardware-based True Random Number Generators (TRNGs) optimized for low-power environments to ensure secure, high-entropy key generation without significant energy overhead.

To further enhance efficiency, the system may employ clock-gating and power-gating techniques within the Hardware Root of Trust (HRoT) environment, enabling selective activation of hardware components only during cryptographic operations. Unused modules may be powered down dynamically to reduce standby energy consumption. For mobile and edge devices, the system may support dynamic voltage and frequency scaling (DVFS), adjusting the power and performance levels of cryptographic operations based on real-time workload demands.

Moreover, lightweight cryptographic algorithms, such as low-power AES variants, elliptic curve cryptography (ECC), and optimized polynomial interpolation methods, may be implemented to complement the low-power hardware. These algorithms are specifically tailored for devices with limited computational and energy resources, ensuring that security processes remain efficient and responsive. For example, polynomial interpolation for key reconstruction may be accelerated using low-power hardware that reduces the number of modular arithmetic operations.

By incorporating low-power hardware integration, the system ensures that secure cryptographic functions may be performed efficiently in energy-constrained devices, extending battery life and enabling deployment in a wide range of applications, including IoT networks, mobile devices, wearables, and edge computing systems. This feature facilitates broad adoption of advanced cryptographic techniques while maintaining the security, reliability, and energy efficiency critical to modern connected environments.

Some embodiments of the systems and methodologies described herein may incorporate scalability and customization to enable flexible deployment across a wide range of environments, from individual devices to large-scale distributed networks. This feature helps to ensure that the cryptographic framework can adapt to varying performance, security, and operational requirements while maintaining efficient resource utilization and robust protection of cryptographic keys.

To achieve scalability, the system is preferably designed to handle an increasing number of users, devices, and cryptographic operations without compromising performance or security. For example, the system may support distributed key management across multiple nodes, leveraging threshold cryptographic techniques such as Shamir's Secret Sharing. In large-scale deployments, key shares may be securely stored and retrieved from a combination of hardware security modules (HSMs), cloud-based encrypted vaults, and decentralized storage systems. The architecture of the system preferably allows for dynamic allocation of resources, enabling efficient processing in environments ranging from low-power IoT networks to enterprise-scale infrastructures.

Customization may be achieved through a modular design that enables the selection and configuration of cryptographic algorithms, security policies, and recovery mechanisms based on specific application requirements. For example, organizations may choose between classical cryptographic schemes, such as RSA or AES, and post-quantum cryptographic algorithms, such as lattice-based or hash-based schemes, to meet evolving security standards. Additionally, the system preferably allows for fine-tuning of features such as key recovery thresholds, multi-factor authentication mechanisms, and key share distribution strategies to align with varying operational needs and threat models.

To enhance adaptability, the system preferably supports policy-driven configurations that can be dynamically updated based on real-time conditions. For example, in high-security scenarios, the system may increase authentication requirements and adjust key recovery thresholds, while in resource-constrained environments, lightweight algorithms and low-power hardware integration may be prioritized. This flexibility helps to ensure that the system can be tailored to meet the performance and security demands of diverse applications, including mobile devices, IoT ecosystems, financial systems, and cloud-based platforms.

By incorporating scalability and customization, the system is better able to evolve alongside changing technological, operational, and security requirements. This adaptability makes the framework suitable for a wide array of use cases, enabling seamless integration into existing infrastructures while providing the performance and security necessary for future growth and expansion.

Some embodiments of the systems and methodologies described herein may incorporate configurable recovery thresholds to provide flexibility and adaptability in the reconstruction of cryptographic keys using threshold-based secret sharing techniques, such as Shamir's Secret Sharing. This feature allows the recovery threshold (that is, the minimum number of key shares required to reconstruct the original cryptographic key) to be dynamically adjusted based on security policies, operational requirements, or contextual conditions. By enabling configurable thresholds, the system provides a balance between accessibility and resilience to unauthorized access.

In one such embodiment, administrators or users may define the recovery threshold during the initial configuration of the system, tailoring the level of security to meet specific needs. For example, a higher threshold (e.g., requiring 5 out of 7 key shares) may be applied in high-security environments where key protection is critical, such as financial institutions or government systems. Conversely, a lower threshold (e.g., 2 out of 5 shares) may be configured for systems prioritizing accessibility and ease of recovery, such as consumer devices or personal data management systems.

The system may also incorporate adaptive thresholding, where the recovery threshold adjusts dynamically based on real-time factors such as risk level, user location, or system activity. For example, the threshold may increase if the system detects suspicious behavior, such as failed authentication attempts, unusual access patterns, or attempts to retrieve key shares from untrusted environments. Conversely, the threshold may decrease under emergency conditions, such as disaster recovery scenarios, to ensure critical access remains available when authorized users require it.

To ensure security during threshold adjustments, the system implements policy-based controls that govern who can modify the recovery threshold and under what conditions. Threshold changes may require multi-factor authentication, administrator approval, or cryptographically signed authorizations to prevent unauthorized manipulation. Additionally, any changes to the threshold configuration may be logged in an immutable audit trail, ensuring transparency and traceability for compliance and forensic purposes.

By incorporating configurable recovery thresholds, the system provides a highly adaptable key recovery mechanism that can respond to varying security needs and operational demands. This flexibility enhances both the security and usability of the system, making it suitable for diverse applications, including secure enterprise systems, disaster recovery frameworks, IoT networks, and user-focused cryptographic platforms.

Some embodiments of the systems and methodologies described herein may incorporate blockchain-based audit logs to ensure immutable, transparent, and verifiable tracking of cryptographic key management operations, including key generation, storage, retrieval, and recovery. By leveraging the decentralized and tamper-resistant properties of blockchain technology, the system provides a robust mechanism for maintaining audit trails that enhance accountability and compliance while protecting against unauthorized modifications or deletions.

In one such embodiment, the system records key management activities, such as the generation of key shares, their distribution across secure locations, and recovery attempts, as individual transactions on a blockchain ledger. Each transaction is cryptographically signed and timestamped to ensure authenticity and accuracy. The use of a decentralized ledger eliminates the risks associated with centralized audit log storage, such as single points of failure or tampering by malicious insiders.

The blockchain-based audit logs may also support selective transparency by allowing authorized parties to verify specific operations without exposing sensitive cryptographic details. For example, a transaction confirming the successful reconstruction of a key may include hashed metadata, ensuring the integrity of the operation while concealing the actual key shares or sensitive inputs. This approach ensures that the audit trail remains verifiable and secure, even in highly regulated or privacy-sensitive environments.

To enhance performance and scalability, the system may integrate with permissioned blockchain networks, where access to the ledger is restricted to trusted entities such as, for example, administrators, compliance officers, or regulatory bodies. These networks allow for efficient consensus mechanisms and control over data visibility while preserving the decentralized and tamper-proof characteristics of blockchain technology. Additionally, smart contracts may be implemented to automate auditing processes, such as triggering alerts for suspicious activities or enforcing compliance policies based on predefined rules.

By incorporating blockchain-based audit logs, the system ensures a secure and transparent audit trail that supports regulatory compliance, forensic analysis, and operational accountability. This feature is particularly beneficial in environments where secure key management is critical, such as financial institutions, healthcare systems, and government infrastructures, providing enhanced trust and resilience against unauthorized activities or data breaches.

Some embodiments of the systems and methodologies described herein may incorporate anomaly detection with artificial intelligence (AI) to enhance security and operational reliability by proactively identifying suspicious activities or deviations from expected patterns in cryptographic key management and usage. Leveraging AI-driven algorithms, the system continuously monitors key management processes, user behavior, and environmental conditions to detect potential threats, such as unauthorized access attempts, compromised key shares, or abnormal recovery activities.

The anomaly detection framework may utilize machine learning (ML) models trained on historical data to establish baselines for normal system behavior. For example, the system may analyze patterns in user authentication attempts, key share retrieval frequencies, and system performance metrics to identify deviations that could indicate malicious activity or system faults. Advanced techniques, such as deep learning or unsupervised learning algorithms, may be employed to uncover subtle anomalies that may not be evident through traditional rule-based systems.

Once an anomaly is detected, the system may initiate a range of automated responses, such as locking access to sensitive key shares, increasing recovery thresholds, or triggering multi-factor authentication for the affected user. Additionally, the system may generate real-time alerts for administrators, providing detailed insights into the nature and context of the anomaly. For example, an alert may include information about unusual recovery requests originating from an untrusted device or network, enabling rapid investigation and remediation.

The AI-powered anomaly detection mechanism may also incorporate context-aware analysis by factoring in environmental and operational data, such as geolocation, time of access, or device trust levels. For example, the system may flag recovery attempts made from unfamiliar geographic regions or during non-standard hours. Furthermore, integration with blockchain-based audit logs may enhance the traceability of detected anomalies, providing a verifiable record of both the events and the responses of the system to them.

By implementing anomaly detection with AI, the system may achieve a proactive and adaptive security posture, capable of responding to evolving threats and operational challenges. This feature not only strengthens the integrity of cryptographic key management but also enhances user trust and compliance with security standards, making it particularly valuable for applications in critical industries such as finance, healthcare, government, and IoT networks.

Some embodiments of the systems and methodologies described herein may incorporate integration with decentralized identity systems to enhance user authentication and cryptographic key management while providing users with greater control over their digital identities. Decentralized identity systems, built on blockchain or distributed ledger technology, allow individuals to create, own, and manage self-sovereign identities (SSIs) without relying on centralized authorities. By integrating with these systems, the cryptographic framework enables secure and seamless identity verification, key recovery, and access management.

In one such embodiment, the system leverages decentralized identifiers (DIDs) to link cryptographic keys and user authentication processes with a user's decentralized identity. These DIDs are stored on distributed ledgers and associated with verifiable credentials, such as biometric data, encrypted PINs, or device-specific certificates. During authentication or key recovery, the system retrieves and verifies the user's identity information through the decentralized network, ensuring trustworthiness without the need for centralized identity providers.

The integration also allows for multi-factor authentication (MFA) that utilizes verifiable credentials stored in the decentralized identity system. For example, a user's biometric hash and cryptographic key shares may be linked to their DID, enabling secure recovery of keys or access to protected systems. The use of verifiable credentials ensures that each authentication attempt is cryptographically signed and tamper-resistant, adding an additional layer of security.

To support interoperability, the system adopts widely recognized standards such as those defined by the World Wide Web Consortium (W3C) for DIDs and verifiable credentials. This ensures compatibility with existing decentralized identity ecosystems and facilitates seamless integration across platforms and applications. Furthermore, blockchain-based audit logs may track identity verification events, providing an immutable and transparent record of user interactions for compliance and accountability purposes.

By incorporating integration with decentralized identity systems, the system enhances security, privacy, and user autonomy. It eliminates the risks associated with centralized identity repositories, such as single points of failure and large-scale data breaches, while providing a robust framework for cryptographic key management. This feature is particularly beneficial for applications in digital identity management, secure financial transactions, IoT ecosystems, and enterprise authentication systems, where both security and user control are paramount.

The above description of the present invention is illustrative and is not intended to be limiting. It will thus be appreciated that various additions, substitutions and modifications may be made to the above described embodiments without departing from the scope of the present invention. Accordingly, the scope of the present invention should be construed in reference to the appended claims. For convenience, some features of the claimed invention may be set forth separately in specific dependent or independent claims. However, it is to be understood that these features may be combined in various combinations and sub-combinations without departing from the scope of the present disclosure. By way of example and not of limitation, the limitations of two or more dependent claims may be combined with each other without departing from the scope of the present disclosure.

What is claimed is:

1. A method for securely generating, storing, and managing cryptographic keys in a Hardware Root of Trust (HRoT)-enabled system, comprising:
generating a cryptographic key using a True Random Number Generator (TRNG) and combining it with a user-defined Personal Identification Number (PIN) and a biometric hash of the user's biometric data;
encrypting the combined key using a Hash-Based Message Authentication Code (HMAC) operation to generate a cryptographically secure and irreversible key;
utilizing Shamir's Secret Sharing to divide the HMAC-generated key into multiple key shares, wherein a threshold number of shares is required to reconstruct the original key;
distributing the key shares across secure storage locations, with at least one share stored within the HRoT environment; and
implementing a recovery mechanism whereby the stored key shares can be retrieved, decrypted, and combined within the HRoT to reconstruct the original cryptographic key upon successful user authentication.

2. The method of claim 1, wherein the cryptographic key is used for digital wallet applications, providing secure generation, backup, and recovery of user credentials and data.

3. The method of claim 1, wherein the distribution of the key shares is implemented such that:
A first share is encrypted using the HRoT-generated public key and stored within the device keychain;
A second share is encrypted and stored in a decentralized system such as the InterPlanetary File System (IPFS); and
a third share is securely stored within a custodial infrastructure controlled by a trusted third-party.

4. The method of claim 1, further comprising a recovery mechanism that retrieves the encrypted key shares from their respective storage locations, decrypts them in a Trusted Execution Environment (TEE), and reconstructs the original key in response to a successful biometric or PIN-based user authentication.

5. The method of claim 1, wherein the HRoT actively monitors and logs each key access attempt to provide an additional layer of security by identifying any unauthorized access attempts.

6. The method of claim 1, wherein the cryptographic key generated by the True Random Number Generator (TRNG) is combined with the user-defined PIN and biometric hash using a Key Derivation Function (KDF), such as PBKDF2, bcrypt, or HKDF, to enhance computational resistance against brute-force attacks.

7. The method of claim 1, wherein the biometric hash is derived from multimodal biometric data, including at least two types of biometric inputs selected from fingerprints, facial recognition, iris scans, or voice patterns, to increase authentication robustness.

8. The method of claim 1, wherein the combination of the cryptographic key, PIN, and biometric hash is performed using a bitwise XOR operation, followed by hashing the result with a cryptographic hash function such as SHA-256.

9. The method of claim 1, wherein the biometric hash is stored in a cancelable biometric format, allowing the regeneration or revocation of the biometric data without storing the raw biometric input.

10. The method of claim 1, wherein the cryptographic key generated by the TRNG is encrypted prior to being combined with the PIN and biometric hash, using a symmetric encryption algorithm such as AES-256.

11. The method of claim 1, wherein the cryptographic key is combined with the PIN and biometric hash in a multi-layered hashing process, wherein each input is separately hashed before being combined and processed using a final hash function.

12. The method of claim 1, wherein the biometric hash is generated using fuzzy cryptography to allow secure matching of biometric data despite minor input variations.

13. The method of claim 1, further comprising dynamic validation of the user-defined PIN and biometric hash, wherein the inputs are revalidated periodically to ensure continuous user authenticity.

14. The method of claim 1, wherein the cryptographic key generated by the TRNG is securely combined with the PIN and biometric hash within a Trusted Execution Environment (TEE) or a Hardware Security Module (HSM).

15. The method of claim 1, wherein the biometric hash includes additional salt values derived from device-specific identifiers or timestamps to further enhance the uniqueness and security of the cryptographic key.

16. The method of claim 1, wherein the HMAC operation utilizes a dynamic secret key generated in real-time using a hardware-based entropy source, such as a True Random Number Generator (TRNG), to prevent key reuse.

17. The method of claim 1, wherein the HMAC operation incorporates a salt value, derived from device-specific identifiers, timestamps, or user session tokens, to ensure uniqueness for each encryption process.

18. The method of claim 1, wherein the HMAC operation uses a nested HMAC process, wherein the output of a first HMAC is further processed through a second HMAC using a different cryptographic hash function or secret key for enhanced security.

19. A hardware root of trust (HRoT) system for securing cryptographic key management, comprising:
a secure key generation module configured to generate a cryptographic key using a combination of TRNG, user PIN, and biometric data;
a key storage module that divides the cryptographic key into multiple shares via Shamir's Secret Sharing, storing each share in distinct secure storage locations; and
an HRoT recovery module configured to reassemble the cryptographic key using a threshold number of shares upon successful user authentication.

20. A method for implementing a secure cryptographic system in a distributed storage environment, comprising:
dynamically generating cryptographic keys using hardware-based entropy sources;
segmenting the generated cryptographic keys into threshold-defined shares using a polynomial-based secret sharing mechanism;
associating each key share with metadata tags denoting storage location and access permissions;
transmitting the key shares via a secure channel to designated storage systems, including a primary share stored within a Hardware Root of Trust (HRoT); and
executing a tamper-evident reconstruction protocol to reassemble the key exclusively within the HRoT upon successful multi-factor authentication.
